(19) United States
(12) Patent Application Publication
(10) Pub. No.: US 2025/0217875 A9
(43) Pub. Date: Jul. 3, 2025

(54) SHORT-FORM VIDEO USAGE WITHIN A FRAME WIDGET ENVIRONMENT

(71) Applicant: Loop Now Technologies, Inc., San Mateo, CA (US)

(72) Inventors: Daniel Scott Rapaport, Redwood City, CA (US); Jing Xian Chen, Dublin, CA (US); Jerry Ting Kwan Luk, Menlo Park, CA (US); Michael A. Shoss, Milton (CA)

(73) Assignee: Loop Now Technologies, Inc., San Mateo, CA (US)

(21) Appl. No.: 18/199,576

(22) Filed: May 19, 2023

Related U.S. Application Data
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/443,063, filed on Feb. 3, 2023.
(60) Provisional application No. 63/438,011, filed on Jan. 10, 2023.
(60) Provisional application No. 63/437,397, filed on Jan. 6, 2023.
(60) Provisional application No. 63/431,757, filed on Dec. 12, 2022.
(60) Provisional application No. 63/430,372, filed on Dec. 6, 2022.
(60) Provisional application No. 63/424,958, filed on Nov. 14, 2022.
(60) Provisional application No. 63/423,128, filed on Nov. 7, 2022.
(60) Provisional application No. 63/414,604, filed on Oct. 10, 2022.
(60) Provisional application No. 63/413,272, filed on Oct. 5, 2022.
(60) Provisional application No. 63/395,370, filed on Aug. 5, 2022.
(60) Provisional application No. 63/388,270, filed on Jul. 12, 2022.
(60) Provisional application No. 63/351,840, filed on Jun. 14, 2022.
(60) Provisional application No. 63/350,894, filed on Jun. 10, 2022.
(60) Provisional application No. 63/344,064, filed on May 20, 2022.
(60) Provisional application No. 63/464,207, filed on May 5, 2023.

(51) Int. Cl. G06Q 30/0601; G06F 16/907; G06F 16/951; G06F 40/143; G06F 40/166; G06Q 30/0207; G06Q 30/08

(52) U.S. Cl. CPC G06Q 30/0643; G06F 16/907; G06F 16/951; G06Q 30/0222; G06Q 30/0239; G06Q 30/0621; G06Q 30/0633; G06Q 30/08; G06F 40/143; G06F 40/166

(57) ABSTRACT

Techniques for video usage within a frame widget retail environment are disclosed. A library of short-form videos is accessed. A website is evaluated for products represented within an online retail environment. One or more products are identified from the webpage that was evaluated. At least one short-form video is chosen from the library to be included in the webpage. The choosing of the at least one video is based on the identified product. A frame widget is inserted into the webpage. The placement of the frame widget is determined by the evaluation of the webpage. The frame widget is populated with at least one video that was chosen along with other videos. The video that was chosen is rendered in the frame widget. The rendering is accomplished by a user action.

### RELATED APPLICATIONS

This application claims the benefit of U.S. provisional patent applications “Short-Form Videos Usage Within A Frame Widget Retail Environment” Ser. No. 63/344,064, filed May 20, 2022, “Manipulating Video Livestream Background Images” Ser. No. 63/350,894, filed Jun. 10, 2022, “Product Card Ecommerce Purchase Within Short-Form Videos” Ser. No. 63/351,840, filed Jun. 14, 2022, “Search Using Generative Model Synthesized Images” Ser. No. 63/388,270, filed Jul. 12, 2022, “Creating And Populating Related Short-Form Video Segments” Ser. No. 63/395,370, filed Aug. 5, 2022, “Object Highlighting In An Ecommerce Short-Form Video” Ser. No. 63/413,272, filed Oct. 5, 2022, “Dynamic Population Of Contextually Relevant Videos In An Ecommerce Environment” Ser. No. 63/414,604, filed Oct. 10, 2022, “Multi-Hosted Livestream In An Open Web Ecommerce Environment” Ser. No. 63/423,128, filed Nov. 7, 2022, “Cluster-Based Dynamic Content With Multi-Dimensional Vectors” Ser. No. 63/424,958, filed Nov. 14, 2022, “Text-Driven AI-Assisted Short-Form Video Creation In An Ecommerce Environment” Ser. No. 63/430,372, filed Dec. 6, 2022, “Temporal Analysis To Determine Short-Form Video Engagement” Ser. No. 63/431,757, filed Dec. 12, 2022, “Connected Television Livestream-To-Mobile Device Handoff In An Ecommerce Environment” Ser. No. 63/437,397, filed Jan. 6, 2023, “Augmented Performance Replacement In A Short-Form Video” Ser. No. 63/438,011, filed Jan. 10, 2023, “Livestream With Synthetic Scene Insertion” Ser. No. 63/443,063, filed Feb. 3, 2023, “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, and “Immediate Livestreams In A Short-Form Video Ecommerce Environment” Ser. No. 63/464,207, filed May 5, 2023.

Each of the foregoing applications is hereby incorporated by reference in its entirety.

### FIELD OF ART

This application relates generally to video manipulation and more particularly to short-form video usage within a frame widget environment.

### BACKGROUND

Shopping has long been a pastime of American and world culture. Prior to advancements made in communications, and especially the Internet, shopping was primarily accomplished through brick-and-mortar stores. Strip malls could be found seemingly everywhere, interspersed with restaurants, movie theaters, and entertainment centers. Malls were heavily attended as vendors, retailers, and service providers attracted customers with discounts and the convenience of multiple stores in one indoor location. However, modern communications have changed shopping forever. Fewer and fewer small brick-and-mortar stores have survived the rush to shop online. Often the larger brick-and-mortar stores that still exist do so only in a complementary fashion with online shopping options. For example, Walmart™ continues to enjoy success with cheap prices in its stores, yet at the same time, the company continues to significantly expand its online offerings. Certainly no one company has embraced the movement toward online shopping more than Amazon™. Starting as a simple online bookstore, Amazon™ has grown into a retail giant, leading the way in online sales year after year. Excellent return policies have helped to assuage any concerns shoppers may have once had about spending hard-earned dollars online.

Online shopping has taken on many forms since its arrival on the retail scene. For example, in the early days of online shopping, cable channels could be found that provided 24-hour access to shopping at home through a television, monitor, etc. connected to a cable feed. Orders were simply made over the phone. Today, “e-tailers”, retailers who sell online merchandise such as Amazon™, Walmart™, Target™ and others, have massive catalogs of products and services that can be purchased with a computer, tablet, personal digital assistant (PDA), phone, and so on. Even grocery shopping can now be done online, allowing consumers to select specific items from the store. Home delivery of online orders is provided, in some cases within hours. An entire world of shopping experiences and conveniences exist for users who simply have an electronic device, an internet connection, and a credit card.

In some cases, the trend toward online shopping has turned consumers into sellers. Auction and resale sites easily allow users to sell used or unwanted items, taking the place of old-fashioned garage sales. In recent years, other popular online sites for selling used merchandise, clothing, and so on have exploded. Instead of setting up a cart at a local mall or store, common websites now allow just about anyone to market and sell homemade arts and crafts online. Popular free advertising sites allow users to list items for sale and arrange for purchase and delivery in person. Service aggregators allow consumers to compare online ratings of businesses and service providers such as plumbers, electricians, babysitters, and so on to help consumers make informed purchasing decisions. Even vacations, which once required a travel agent, can now be purchased fully online. For example, nearly every airline offers online searching, payment, booking, and check-in of flights. Hotels can easily be booked online as well. Travel aggregators combine flights, hotels, and rental car options from many different providers for one-stop online vacation shopping. Virtually every aspect of shopping has migrated online. That trend is likely to continue as technology continues to advance.

### SUMMARY

The use of short-form videos has grown tremendously in recent years. Cell phones, tablets, laptops, etc. all have the built-in ability to play video content both at home and on the road. Younger users especially can spend long periods of time consuming short-from video content such as livestreams, bloopers, sports highlights, news, weather, product reviews, and more. Watching short-form videos has simply become a way of life with important implications. For example, online shopping has seen tremendous growth in popularity. At the same time, it has been well documented that attention spans have decreased significantly as a result of short-form video consumption. To maintain users' ever shortening attention spans, creative ways to advertise products are needed. New and intelligent ways to use short-form videos within a retail application have become critical for online merchants to remain relevant, as video consumption inevitably continues to rise and attention spans continue to shrink.

Disclosed herein is a computer-implemented method of using short-form videos within a frame widget environment. Almost every retail merchant, from casual individual sellers to large companies, employs webpages to generate revenue through online sales. These webpages can focus on a particular topic, highlight a company, rate a product, and so on while facilitating sales of products or services in an online retail application or environment. An e-tailer, manufacturer, advertiser, etc. can creatively leverage short-form videos by first accessing a library of short-form videos. The videos can be made by anyone—social media influencers, internet celebrities, tastemakers, celebrities, etc. The videos, which can typically run for a duration of 30 seconds to 10 minutes or so, can highlight one or more products which can be available for purchase by a viewer. The videos can include sponsored, promotional, or organic videos and can be livestream videos, livestream replays, and the like.

The website can be evaluated for products displayed by detecting and evaluating keywords, scrubbing the webpage for images, determining context of the webpage, analyzing audio, and searching for lookalike cohort metadata. One or more products on the webpage that are discussed, evaluated, available for purchase, etc. can then be identified. Products that are related to those found on the website, including, for example, a carton of milk or a car wash ticket, can be identified. Machine learning can be used to identify the products on the webpage based on the evaluating. One or more short-form videos from the library of videos can be chosen based on the evaluation of the webpage. The short-form videos can relate to the content of the website, images on the website, products that were identified on the website, and so on. Metadata can be used to select videos that are appropriate for the content on the webpage or appeal to the potential interests of the viewer. The choosing of the at least one short-form video from the library can be based on machine learning.

A frame widget can be inserted into the webpage. The frame widget can have borders which separate the videos. The widget can display buttons, arrows, diagrams, lines, etc. to rotate, shift, move, etc. videos into focus for playing based on a viewer's action such as a click, tap, etc. The frame widget can include a short-form video carousel including at least two short-form videos, a short-form video story block including at least one short-form video, a grid of at least two short-form videos, or a floating short-form video player including at least one short-form video. The frame widget can be populated with videos which were chosen along with other videos and can include thumbnail representations. The thumbnail representations can include an image, a picture from the video, graphics, emojis, stick figures, and so on. An auction bid, from a manufacturer, distributor, advertiser, etc., can be based on the position of videos populated within the frame. In embodiments, the auctioning is based on the position of the frame, the use of coupons, the use of keywords, relevance to the website, etc.

One or more short-form videos can be rendered within the frame widget based on a user action such as clicking, tapping, mousing over a button, etc. The rendering can be accomplished within the frame widget so that the video can be entirely viewed on various devices such as a computer, tablet, PDA, cell phone, and so on. The rendering can occur automatically after a period of time, or as soon as it comes into view by the user, or based on a user action such as a click, tap, etc. The videos can include products, where the products can be available for display, advertising, review, purchase, and so on. The products can be sold by a vendor, e-tailer, etc. on a third-party website and can be represented by an image, graphic, etc. in the rendered video. The rendering can include an overlay such as an image of a product, a call-to-action overlay, product information, a coupon, etc. “on top” of the video or a portion of the video. An in-frame shopping environment can be revealed based on another user action such as a click, tap, etc. The products can be selected for purchase, by the person viewing the video, by interacting with a call-to-action overlay within the in-frame shopping environment. The call-to-action overlay can include an image, graphic, text such as “get deal”, and so on. The interacting can include clicking, tapping, hovering over a cursor, and so on. The revealing of the in-frame environment can include showing a product details page. The product details page can include any information that would be useful in making a purchase decision about the product such as quantity, size, color, brand, ratings, cost, shipping details, terms and conditions, nutritional information, and so on. A virtual shopping cart can be enabled within the frame widget based on a user action such as a click, tap, etc. As the short-form video is playing, the viewer can observe one or more products within the video. The user can select a product for purchase into the virtual purchase cart via the in-frame shopping environment. As the video continues to play, the product that was selected can be represented in the cart. The cart can be displayed in the same frame as the video while the video is viewed. In embodiments, the user displays a product details page for information regarding the selected product. The product details can be loaded from a database that supports hydration of data in an e-commerce environment. To support e-commerce checkout, the enabling of the virtual shopping cart can include identifying the user by a hash identification tag which can be used to complete checkout from the virtual shopping cart in a third-party website.

A computer-implemented method for video manipulation is disclosed comprising: accessing a library of short-form videos; evaluating a webpage for products displayed or represented through the webpage within an online retail environment; identifying one or more products on the webpage based on the evaluating; choosing at least one short-form video from the library of short-form videos to include with the webpage, wherein the choosing is based on the identifying; inserting a frame widget into the webpage, wherein placement of the frame widget in the webpage is based on the evaluating; populating the frame widget with the at least one short-form video that was chosen along with other videos; and rendering a video from the frame widget, based on a user action, wherein the video is from the at least one short-form video that was chosen.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for populating and playing short-form videos in a frame widget on a webpage.

FIG. 2 is a flow diagram for enabling short-form video selection, evaluation, and an in-frame shopping environment.

FIG. 3 shows a block diagram of an example frame widget.

FIG. 4 illustrates a short-form video playing in a carousel frame widget.

FIG. 5 illustrates an in-frame shopping environment with multiple products.

FIG. 6 illustrates an in-frame shopping environment with a single product.

FIG. 7 illustrates an in-frame shopping environment with a product details page.

FIG. 8 is a system block diagram for in-frame displaying of products for purchase with a frame widget.

FIG. 9 is a system block diagram for an add-to-cart operation.

FIG. 10 is a system diagram for short-form videos displayed in a frame widget within a retail environment.

### DETAILED DESCRIPTION

Techniques for short-form video usage within a frame widget environment are disclosed herein. As social media has exploded in popularity, more and more users have become comfortable with living increasingly online. One of the implications of this massive shift in behavior is the meteoric rise in the popularity of online shopping. While brick-and-mortar stores have seen less foot traffic and once-filled malls continue to empty, the convenience of online shopping is fueling significant growth year after year. The growth of social media has also led to the explosion of the use of short-from video online. Users can now spend hours a day simply watching livestreams, how-to videos, cooking videos, sports clips, movie reviews, memes, and so on. While entertaining, the expanded use of video has been proven to have at least one unintended consequence—the general lowering of attention spans, especially in younger users. These two trends, increased online shopping and lowered attention spans, have combined to form a perfect storm for e-tailers. Standing out in a world of ever-increasing competition is hard enough, especially against larger online stores and warehouses. Attracting interest while would-be customers are distracted watching hours of short-form video content borders on the impossible.

The disclosed method for using short-form videos in a retail application or environment leverages trends in social media to help e-tailers, manufacturers, advertisers, etc. promote and sell products. A webpage on a device such as a laptop, tablet, cell phone, etc. can be modified to include a frame widget holding one or more videos which relate to the content of the website. The frame widgets can include carousel, story block, grid, and floating short-form video player frame widgets to display and render videos in unique ways to the viewer. The website can be evaluated by detecting and evaluating keywords, scrubbing the webpage for images, determining the context of the webpage, analyzing audio, and searching for lookalike cohort metadata. The videos can be livestreams, livestream replays, and other types of videos which are commonly found on social media, maximizing the e-tailer's chances of maintaining the user's attention.

The videos can be rendered on the website based on a user action such as a click, tap, etc. In embodiments, the videos can play automatically when they come into the users view to attract and keep attention. As the video is viewed, the user can become interested in products that are displayed, promoted, reviewed, and so on. To foster interest and promote sales, the videos can include coupons. The coupons can appear after watching the video, after a threshold period of time, or immediately. A call-to-action overlay can be added to the video to entice the user to purchase the product. The call-to-action overlay can be an image, video, graphic, text such as “Get Deal”, etc.

An in-frame shopping environment can be displayed in the frame widget based on another user action such as clicking, tapping, etc. on the call-to-action overlay. The in-frame shopping environment allows the user to place products into a virtual purchase cart while still viewing the content of the video. In this manner, the e-tailer can provide information, promotions, etc. about products for sale without interrupting the flow of the video, thus further increasing the chances of maintaining the user's attention while shopping for products.

The position and selection of the videos within the widget frame can be based on an auction bid from an advertiser, manufacturer, distributor, etc. A higher auction bid can be used, required, suggested, etc. when a video within the frame widget automatically plays instead of waiting for a user action such as a click, mouse-over, tap, swipe, etc. A higher auction bid can also be used depending on the relevance of the video to content on the website. Allowing for an auction-based system of populating the frame widget can allow for the most relevant videos and products to be advertised on the website, further increasing the chances of a sale.

A virtual shopping cart, or virtual purchase cart, can be enabled within the frame widget based on a user action such as a click, tap, etc. The user can select a product for purchase and place it into the virtual purchase cart via the in-frame shopping environment. The selection includes the ability to update quantity, price, size, color, or other variable aspects of the product. The user can choose from multiple related products. The virtual shopping cart can include the ability for the user to clip coupons that were shown during the video. All of these selections and options in the virtual shopping cart, including the ability to perform an e-commerce checkout, can be accomplished while the video plays to maintain the attention of the user.

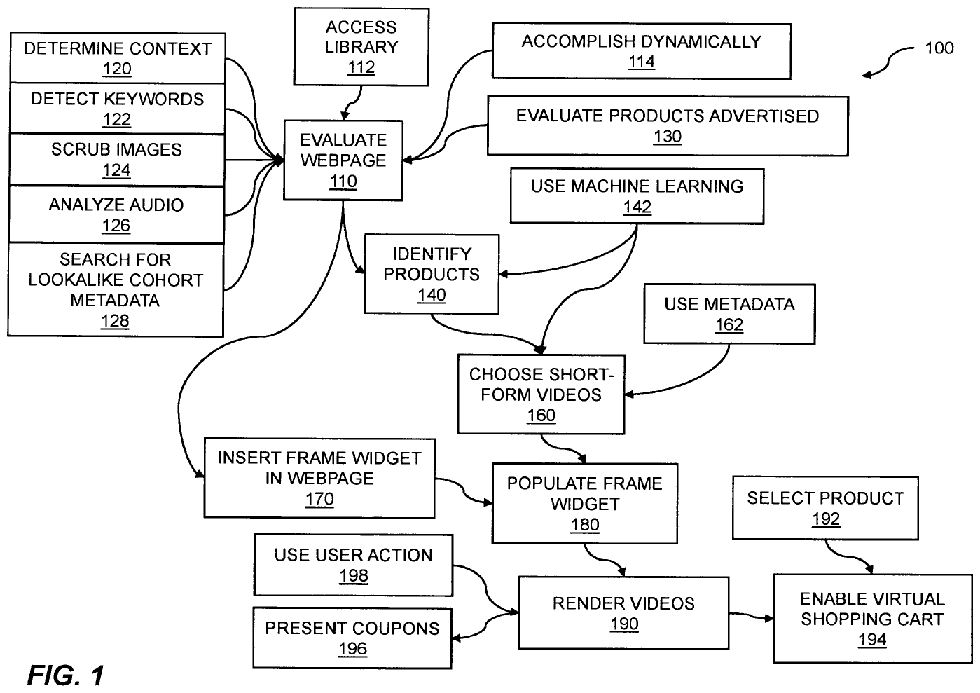

FIG. 1 is a flow diagram for populating and playing short-form videos in a frame widget on a webpage. The webpage is evaluated and products that are highlighted, discussed, rated, for sale, etc. on the webpage are identified. At least one short-form video from a library, that matches the highlighted products, is chosen. A frame widget is inserted into the webpage that was evaluated and the at least one video is populated, along with other videos, within the frame widget. The videos, which can include coupon overlays; call-to-action overlays; and overlays for images, graphics, icons, etc., are rendered to the user. In embodiments, a product details overlay can be rendered. In other embodiments, an in-frame shopping environment can be revealed based on a user action such as a click, tap, etc. The in-frame shopping environment allows the user to update quantity, price, size, color, or other distinguishing characteristics/dimensions before selecting the product to be placed in the virtual cart. A virtual shopping cart is enabled, allowing the viewer to select products for sale, apply or “clip” coupons, and make purchases through an online checkout process.

The flow 100 describes a computer-implemented method for populating and playing short-form videos in a frame widget on a webpage. The flow 100 includes accessing a library of short-form videos 112. The library of short-form videos can be stored on and/or streamed from a server and can include livestream videos or livestream video replays. In certain embodiments, the video library stores metadata associated with each short-form video, which can include hashtags, repost velocity, user attributes, user history, ranking, product purchase history, view history, user actions, and the like. The videos can include content made by just about anyone, including social media influencers, internet celebrities, tastemakers, instructors, companies, distributors, and so on. The videos, which can typically run for variable durations such as 30 seconds, 10 minutes, 30 minutes, or longer, can highlight one or more products and/or services which can be available for purchase by a viewer. The videos can include sponsored videos which are provided by manufacturers, distributors, sellers, etc. of the products that can be promoted, highlighted, endorsed, critiqued, demonstrated, compared, etc. within the video. The videos can include promotional videos which can present coupons, apply discounts, personalize prices, offer multiples of the same item for a price, and so on, to entice the viewer to purchase a product or service. The short-form videos, which can highlight the webpage, online store, online shopping environment, provider of the environment, owner of the website, and so on, can be organic.

The flow 100 includes evaluating a webpage 110 for products displayed or represented through the webpage within an online retail environment. The webpage can be an application display running on a computer device such as a phone, tablet, computer, etc. Anyone with something to say, sell, demonstrate, etc. can create the webpage. The webpage can focus on a particular topic, highlight a company, show off a product, and so on. The evaluating a webpage can be accomplished dynamically 114 or beforehand by WebCrawlers, spiders, bots, etc. in anticipation of a future view by the user. The evaluating a webpage can include detecting and evaluating keywords 122, scrubbing the webpage for images 124, determining context 120 of the webpage, analyzing audio 126, and searching for lookalike cohort metadata 128. In some embodiments, the widget can reside on or within a software application. In alternative embodiments, the widget can reside within or be accessed using an operating system or virtual environment.

Determining context 120 of the webpage can include studying the URL, examining underlying code associated with the page, examining links, or examining any other type of information related to the webpage, the website, the user, the circumstances of the viewing, and so on. Detecting keywords can include finding any word, phrase, word grouping, sentence, and so on used on a website that may provide insight into the website's content. Detecting keywords can also include performing Latent Semantic Indexing (LSI) on the webpage to discover semantically related terms. Scrubbing for images 124 can include graphics, videos, emojis, stick figures, and so on. Scrubbing for images can include examining any data associated with the image, such as source files, file format, copyright information, metadata information, color, etc. Scrubbing can also include machine learning to perform image recognition and classification. Analyzing audio 126 can include annotation, speech recognition, natural language processing, and so on based on audio from videos, podcasts, music, etc. found on the website or linked from the website. Searching for lookalike cohort metadata 128 can include one or more users with similar metadata patterns including user attributes, user history, product purchase history, view history, user actions, etc. Lookalike cohort metadata can be used to anticipate and determine the content of the webpage based on actions of users with similar metadata patterns to the user. Evaluating products advertised 130 can include products listed in text, displayed in picture format or video format, represented by a line drawing or icon, etc. Anything advertised, listed for sale, reviewed, etc. on the website can be used to collect information and aid the evaluating.

The flow 100 includes identifying one or more products on the webpage 140 based on the evaluating. The products can include items or services, for example, cans of soda, milk, socks, baseball cards, diapers, a 20-minute massage, etc. The products can be discussed, evaluated, made available for purchase, etc. on the website, or can be related to products or services found on the website. The products can include features such as quantity, size, color, brand or any other identifying feature of the item or service. In some embodiments, identifying one or more products from the evaluation of the webpage is based on machine learning 142 to find products related to the webpage that can be of interest to the viewer.

The flow 100 includes choosing short-form videos 160. At least one short-form video is chosen from the library of short-form videos to include with the webpage. The chosen short-form video is based on the evaluation of the webpage. The short-form videos can relate to the content of the website, images on the website, products that were identified on the website, and so on. In embodiments, metadata is used 162 in the choosing of the at least one short-form video from the library to select videos that can match the content on the webpage or potential interests of the viewer. The choosing of the at least one short-form video from the library can be based on machine learning.

The flow 100 includes inserting a frame widget in the webpage 170. The placement of the frame widget in the webpage is based on the evaluating. In embodiments, the inserting is accomplished dynamically. The frame widget can be stored on a server and can be inserted into the webpage, for example, with HTML embedded code anywhere on the webpage. The frame widget can stretch or shrink so that it can be displayed on numerous computer devices such as a computer, tablet, phone, etc. The frame widget can have borders which separate the videos, as well as buttons, arrows, and so on, which rotate, shift, move, etc. videos into focus for playing based on a viewer's action such as a click, tap, etc.

The frame widget can be a carousel frame widget. The carousel frame widget can display at least two short-form videos and can include borders separating the videos. The carousel frame widget borders can have different colors, widths, sizes, etc. Additional videos can be displayed by the user by scrolling videos left and right in the widget based on a user action such as a click, tap, etc. The frame widget can be a story block frame widget. The story block frame widget can display at least one short-form video within the story block frame border. The active video can remain in the front of the story block frame widget while additional videos can have their views partially obstructed. In embodiments, the additional videos are blurred, obscured, tinted, overlayed, colored, and so on, to show that they remain in the background. The story block frame border can have different colors, widths, sizes, etc. The story block frame widget can allow users to scroll videos left and right so that a new video can be displayed in the front of the story block widget. The frame widget can be a grid frame widget. The grid frame widget can display at least two short-form videos in a grid format layout. The grid layout can contain one or more videos in both the x and y directions and can include borders separating the videos. The grid frame widget borders can have different colors, widths, sizes, etc. The frame widget can be a floating short-form video player widget including at least one short-form video. The floating short-form video player widget can have a border of different colors, widths, sizes, etc.

The flow 100 includes populating the frame widget 180 with at least one short-form video that was chosen along with other videos. The populating can include organic, sponsored, and promotional videos. When the number of short-form videos in the frame widget is too large for all of them to be displayed in the frame at the same time, the populating can add an indicator such as an arrow, button, etc. to indicate to the viewer that additional short-form videos are available by scrolling in a specified direction. The viewer can access these additional short-form videos by tapping, clicking, mousing over, etc. the indicator, causing the populating of additional videos that were chosen to occur as they are revealed in the frame.

The flow 100 includes rendering a short-form video 190. The rendering is based on a user action such as tapping, clicking, mousing over a button, etc. on the video that was chosen. The rendering can be accomplished within the frame widget. The rendering is accomplished so that the video can be entirely viewed on various devices such as a computer, tablet, PDA, cell phone, and so on. The rendering can occur automatically after a period of time, or as soon as it comes into view by the user. The videos can include one or more products, where the products can be available for display, advertising, review, purchase, and so on. The products can be sold by a vendor, e-tailer, etc. on a third-party website. The products can be represented by an image, graphic, etc. overlay in the rendered video. An in-frame shopping environment can be revealed based on another user action such as a click, tap, etc. The products can be selected for purchase, by the person viewing the video, by interacting with a call-to-action overlay within the in-frame shopping environment. The call-to-action overlay can include an image; graphic; text such as “get deal”, “buy”, “buy now”; and so on. The interacting can include clicking, tapping, hovering a cursor, and so on. In embodiments, the rendering of the video can present coupons 196. The coupons can be presented in an overlay to the user. The in-frame shopping environment can include the ability for the user to clip coupons. Coupons can include applied discounts, (e.g., “$1.99 each”), personalized price (e.g., a special price for members of a club), multiple same items for a price offers (e.g., “3 for $0.99”), buy one get one free (“BOGO”), and so on. The rendering of overlays can be rendered “on top” of the video or a portion of the video. The video, including any overlays, can be rendered initially at a position within the frame widget and can be moved to another position based on an action taken by the user. The video and all overlays can be expanded to cover the entire screen of the device.

The flow 100 includes enabling a virtual shopping cart 194. The virtual shopping cart is enabled within the frame widget based on a user action 198 such as a click, tap, etc. As the short-form video is playing, the viewer can observe one or more products within the video. The user can select a product 192 for purchase into the virtual purchase cart via the in-frame shopping environment. In embodiments, the user updates quantity, price, size, color, or other variable aspects of the product before selecting it for placement in the virtual cart. The user can choose from multiple related products to be added into the cart. As the video continues to play, the product that was selected can be represented in the cart. The cart can be displayed in the same frame as the video while the video is viewed. In embodiments, the user displays a product details page for information regarding the product. The product details can be loaded from a database that supports hydration of data in an e-commerce environment. To support e-commerce checkout, the enabling of the virtual shopping cart can also include identifying the user by a hash identification tag which can be used to complete checkout from the virtual shopping cart in a third-party website. In embodiments, the virtual shopping cart can be unique to the video itself. In other embodiments, the virtual shopping cart can be accessed through any of the short-form videos. In embodiments, the virtual shopping cart is accessed via a shopping cart from a retailer's website or application while the video is playing. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

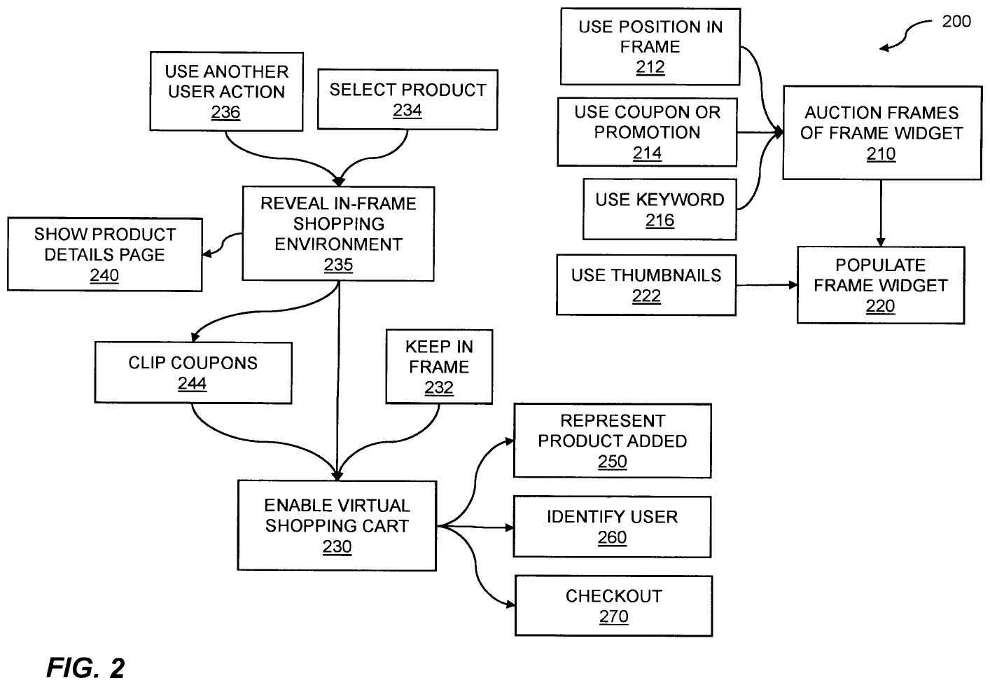

FIG. 2 is a flow diagram for enabling short-form video selection, evaluation, and an in-frame shopping environment. A carousel frame widget, story block frame widget, grid frame widget, or floating short-form video frame widget can be inserted in a webpage and at least one video can be played based on a user action. An auction bid can be based on the position of videos within the frame. In embodiments, the auctioning is based on the position of the frame, the use of coupons, the use of keywords, the relevance of the video to the website, etc. As the video plays, one or more products can be selected based on another user action such as a click, tap, swipe, etc. The selection can be accomplished by an in-frame shopping environment. The in-frame shopping environment can show product details, enable a virtual shopping cart, etc. The shopping cart can represent products that have been added, can identify the user, and can complete the checkout process.

The flow 200 includes auctioning frames of a frame widget 210. The auctioning includes at least one frame in the frame widget. Any frame of the widget can be auctioned to a bidder which can include an advertiser, distributor, manufacturer, retailer, etc. The auctioning can be based on the position of the short-form video in the frame widget 212. In a usage example, the leftmost frame or the center frame can merit higher bid suggestions based on their location in the frame. In another usage example, a higher auction bid can be used, required, suggested, etc. when a video within the frame widget automatically plays instead of waiting for a user action such as a click, mouse-over, tap, swipe, etc.

The auctioning can be based on the use of a coupon or other promotion 214. The auctioning frames can be based on different types of coupons, each frame using a different kind of coupon, etc. The auctioning frames can be based on a keyword 216. The keyword can be any word, phrase, word grouping, sentence, and so on used on the website or related to content on the website. Each keyword can have a different bid amount based on the relevance of the keyword to the content of the website.

The flow 200 includes populating the frame widget 220. The populating the frame widget can include thumbnail representations 222 of the at least one short-form video that was chosen, along with other videos. The thumbnail representations can include an image, a picture from the video, graphics, emojis, stick figures, and so on. The thumbnail representation can be designed to entice the user to click on the video. The flow 200 includes revealing an in-frame shopping environment 235. The revealing of the environment is based on another user action 236 such as a click, tap, swipe, etc. As the short-form video plays, the viewer can observe one or more products within the video. The user can select a product 234. The selecting a product can be based on a call-to-action overlay. The call-to-action overlay can be an image of the product, a video, a diagram, text such as “buy now”, and so on. The selecting a product can reveal an in-frame shopping environment 235 where the user can update quantity, price, size, color, or other variable aspects of the product. The shopping environment can include the ability to choose from multiple related products. In embodiments, the shopping environment includes the ability for a user to “clip” coupons 244. Coupons can include multiple types including, but not limited to, rebates, free offers, “$x off grocery bill when you do y”, and so on. The revealing can include showing a product details page 240. Showing the product details pages can be based on the call-to-action overlay. The product details page can include any information that would be useful in making a purchase decision about the product, such as quantity, size, color, brand, ratings, cost, shipping details, terms and conditions, nutritional information, and so on. In embodiments, the product details page is loaded from a database that supports hydration of data in support of an e-commerce activity. The data can be obtained from a website hosted by a third party. The third-party website can include an information source, a search engine, an online retailer, and so on. The third-party website can include product information in the form of images, audio, text, videos, and the like.

The flow 200 includes enabling a virtual purchase cart 230. The enabling can occur within the frame widget 232 based on a user action such as a click, tap, etc. One or more products that were selected by the user in the in-frame shopping environment can be added to the virtual purchase cart. The products added can be represented in the cart 250. The representation can include an image, a picture from the video, and so on. The representing the product that was added to the virtual purchase cart can be accomplished while the user views the video. The enabling of the virtual shopping cart can also include identifying the user 260. The identifying can be based on a hash identification tag, cookies, an IP address, and so on. The enabling can include completing checkout from the virtual shopping cart 270. The checking out can be completed from the virtual shopping cart or from a third-party website. Various steps in the flow 200 can be changed in order, repeated, omitted, or the like without departing from the disclosed concepts. Various embodiments of the flow 200 can be included in a computer program product embodied in a non-transitory computer readable medium that includes code executable by one or more processors.

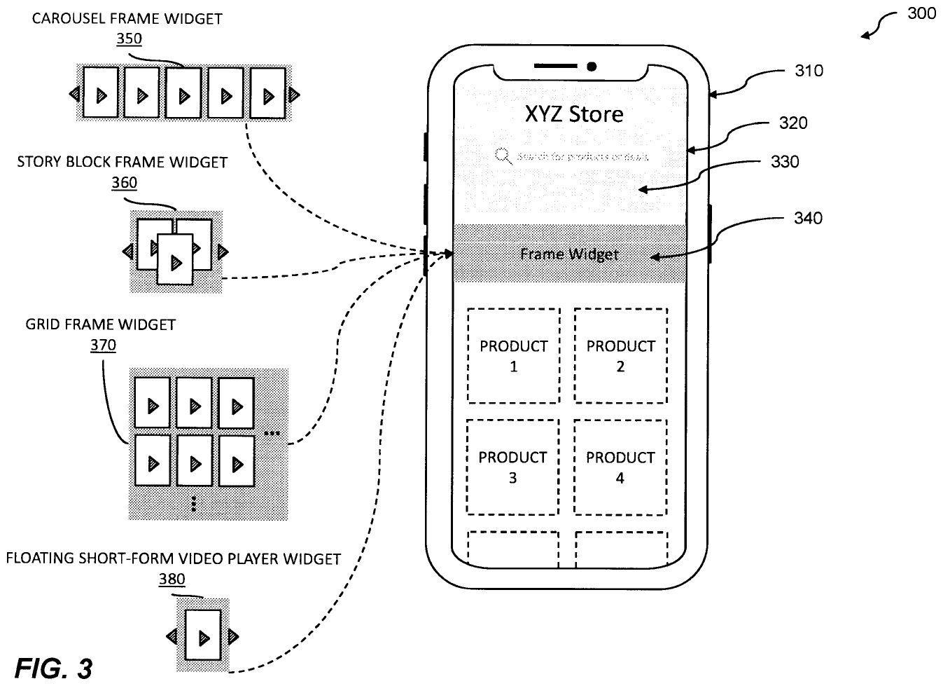

FIG. 3 shows an example frame widget. A frame widget can be inserted into a webpage viewed on a device by a user. The frame widget can display a number of videos specific to the type of frame widget inserted into the webpage. The frame widget can be inserted anywhere on the webpage. The videos that are rendered in the frame widget can be based on the content of the webpage.

The block diagram 300 can include a device 310. The device can be a computer, streaming device, PDA, tablet, phone, and so on that can display a webpage 320. The webpage can focus on a particular topic; highlight a specific product, item, etc.; show a collection of disparate items, stories, videos, etc.; and so on. The webpage can be an online store featuring products for sale 330. A frame widget 340 can be inserted into the webpage. In embodiments, the inserting is accomplished dynamically. The frame widget can be stored on a server and can be inserted on the webpage, for example with HTML embedded code, anywhere on the webpage. The frame widget can stretch or shrink so that it can be displayed on numerous computer devices such as a computer, streaming device, phone, etc. The frame widget can have borders which separate the videos, as well as buttons, arrows, diagrams, lines and so on which rotate, shift, move, etc. videos into focus for playing by the user. More than one frame widget of various types can be inserted into the webpage.

The frame widget can be a carousel frame widget 350. The carousel frame widget can display at least two short-form videos and can include borders separating the videos. The carousel frame widget borders can have different colors, widths, sizes, etc. The carousel frame widget can allow users to scroll videos left and right, up and down, etc. so that additional videos can be displayed in the carousel frame widget. The frame widget can be a story block frame widget 360. The story block frame widget can display at least one short-form video within the story block frame border. The active video can remain in the front of the story block frame widget while additional videos can have their views partially obstructed. In embodiments, the additional videos can be blurred, obscured, tinted, overlayed, colored, and so on to show that they remain in the background. The story block frame border can have different colors, widths, sizes, etc. The story block frame widget can allow users to scroll videos left and right, up and down, etc. so that a new video can be displayed in the front of the story block widget. The frame widget can be a grid frame widget 370. The grid frame widget can display at least two short-form videos in a grid format layout. The grid layout can contain one or more videos in both the x and y directions and can include borders separating the videos. The grid frame widget borders can have different colors, widths, sizes, etc. The frame widget can be a floating short-form video player widget 380 including at least one short-form video. The floating short-form video player widget can have a border of different colors, widths, sizes, etc.

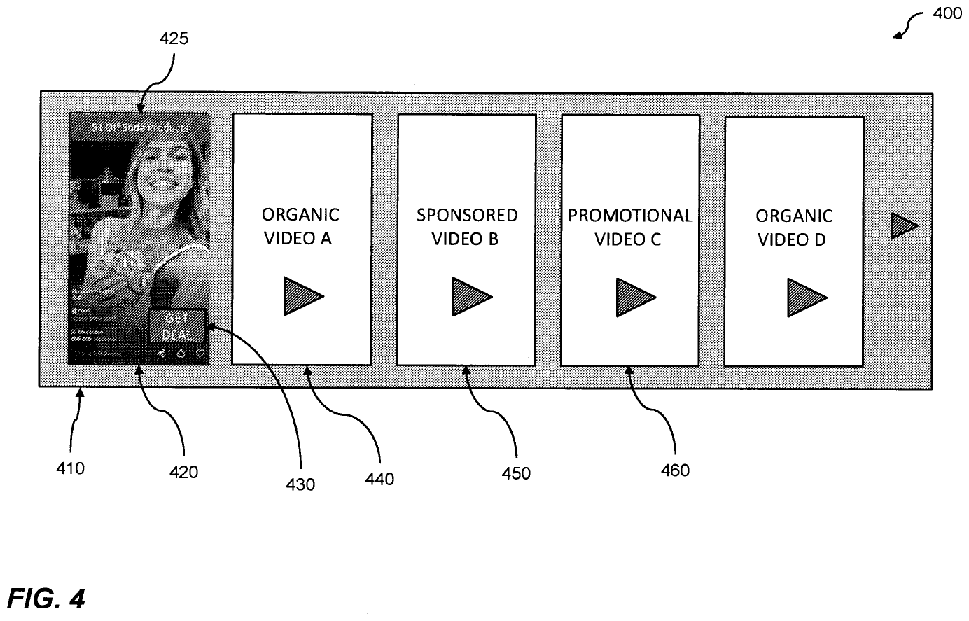

FIG. 4 is a diagram of a short-form video playing in an example frame widget. A frame widget can be populated by one or more videos. The videos populating the frame widget can include videos that relate to the content of the website, images on the website, products that were identified on the website, and so on. The short-form videos can include sponsored, organic, or promoted videos made by social media influencers, celebrities, marketers, a company, a distributor, and so on. The videos can include a coupon for a product that can be purchased on the website.

The block diagram 400 can include an example carousel frame widget 410 inserted into a webpage. The frame widget can include at least one video 420. The video can be represented by a thumbnail. The thumbnail representations can include an image, a picture from the video, graphics, emojis, stick figures, and so on and can be designed to entice the user to click on the video. The video can be rendered for the user to view immediately, after a time delay, in response to a user action, and so on. The rendering of the short-form video can present a coupon overlay 425 to the user. The coupon overlay can appear in any location over the video. The coupon can be revealed to the user immediately, after watching the short-form video for a period of time, based on a user action, and so on. The coupon overlay can include discounts, offers, sales, etc. A frame in the frame widget can be reserved for a type of coupon, for example, “buy one, get one free”. The user can select the coupon by an action such as clicking, tapping, mousing over, etc. on a call-to-action overlay in the video 430.

Other videos rendered in the frame widget can include organic videos 440, sponsored videos, 450, or promotional videos 460. Organic videos 440 can highlight a topic, perform a review, focus on the webpage, discuss the online store, point out the owner of the website, and so on. Sponsored videos 450 can be provided by manufacturers, distributors, sellers, etc. of the products identified on the website that can be promoted, highlighted, endorsed, critiqued, demonstrated, compared, or otherwise presented within the short-form video. Promotional videos 460 can present coupons, applied discounts, personalized prices, multiple same items for a price offers, and so on, to entice the viewer to purchase a product or service.

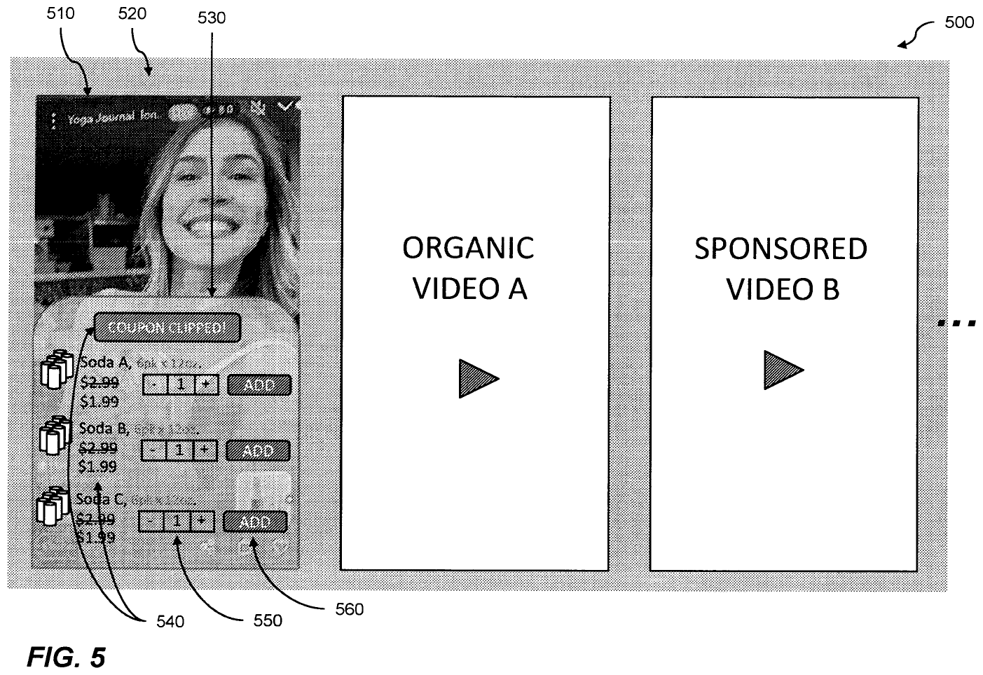

FIG. 5 illustrates an in-frame shopping environment with multiple products. The diagram 500 can include a video 510 that is rendered to a viewer within an example carousel frame widget 520 based on a user action such as a click, tap, etc. Once a product is selected from the video by a user action such as a click, tap, etc., the in-frame shopping environment 530 can be revealed as an overlay to the video. The video can continue to play while the shopping environment is displayed. The revealing of the in-frame shopping environment can include the ability for the user to clip coupons 540. The coupons can be offered as a video overlay from the manufacturer, distributor, retailer, etc. The viewer can update purchase details 550 before adding the product into the virtual shopping cart. The in-frame shopping environment can include the ability for the user to choose from multiple products. When ready, the user can add 560 one or more products desired to a virtual purchase cart to check out.

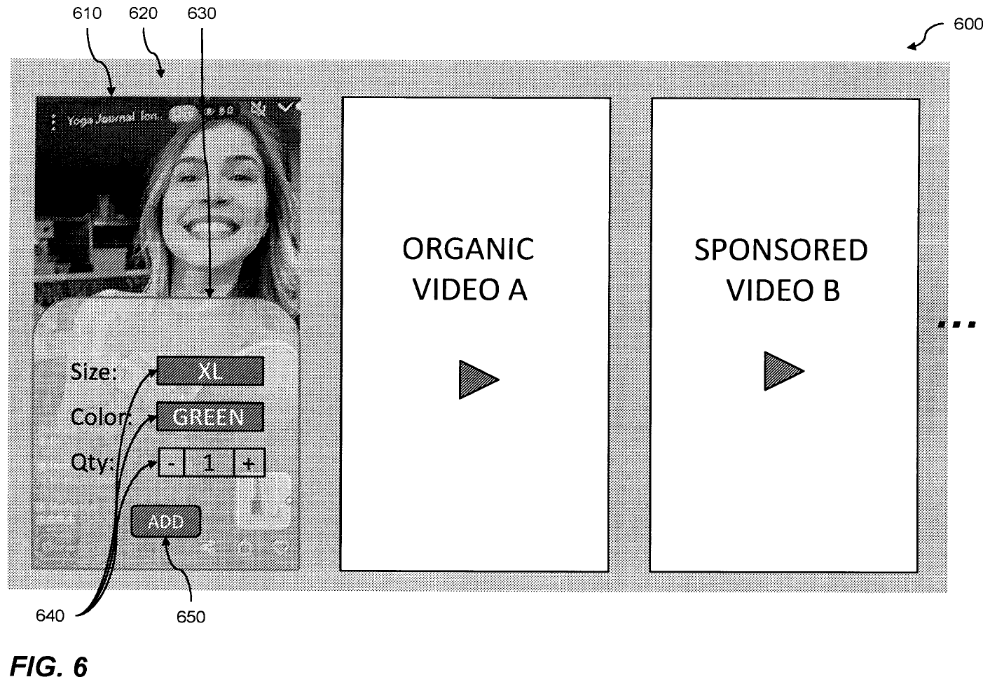

FIG. 6 illustrates an in-frame shopping environment with a single product. The diagram 600 can include a video 610 that is rendered to a viewer within an example carousel frame widget 620 based on a user action such as a click, tap, etc. A product can be selected from the video by another user action such as a click, tap, etc. which reveals the in-frame shopping environment 630. The in-frame shopping environment can be displayed as an overlay to the video. The environment can include the ability for the user to update the quantity, price, size, color, or other variable aspects of a product 640. When ready, the user can add the product 650 to a virtual purchase cart to check out.

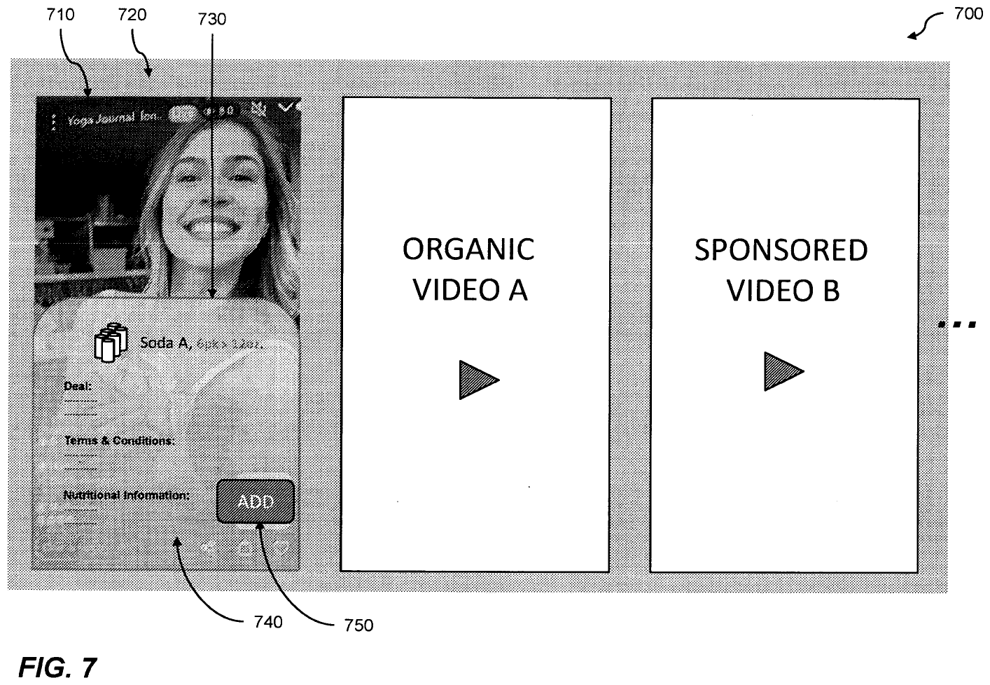

FIG. 7 illustrates an in-frame shopping environment with a product details page. The diagram 700 can include a video 710 that is rendered to a viewer within an example carousel frame widget 720 based on a user action such as a click, tap, etc. A product can be selected from the video by another user action such as a click, tap, etc. which reveals the in-frame shopping environment 730. The in-frame shopping environment can be displayed as an overlay to the video. The revealing of the in-frame environment can include showing a product details page 740. The product details page can include any information that would be useful in making a purchase decision about the product, such as quantity, size, color, brand, ratings, cost, shipping details, terms and conditions, nutritional information, and so on. In embodiments, the product details page is loaded from a database that supports hydration of data in support of an e-commerce activity. The data can be obtained from a website hosted by a third party. The third-party website can include an information source, a search engine, an online retailer, and so on. The third-party website can include product information in the form of images, audio, text, videos, and the like. When ready, the user can add the product 750 to a virtual purchase cart to check out.

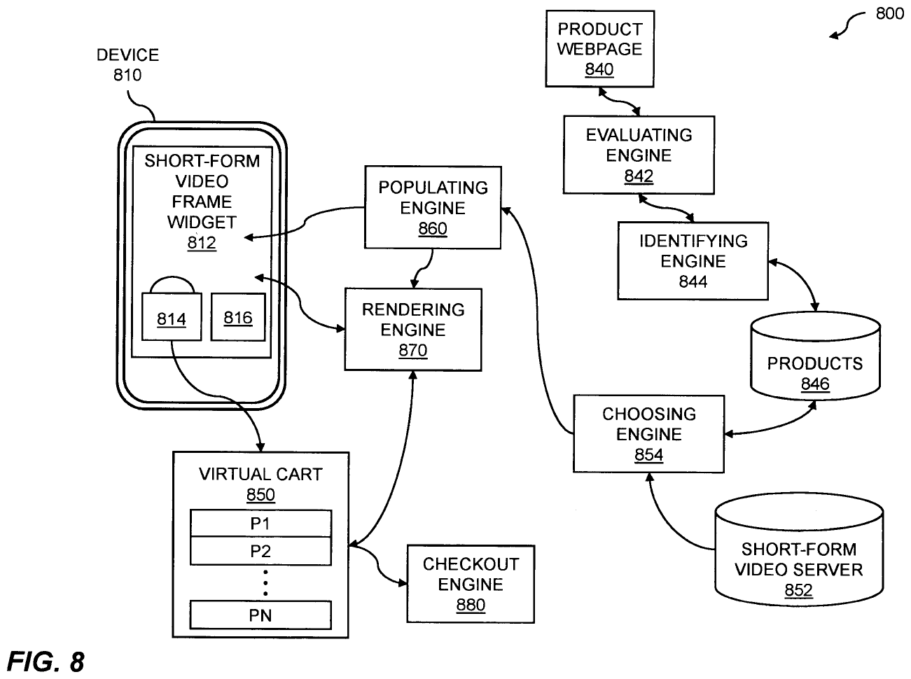

FIG. 8 is a system block diagram for in-frame displaying of products for purchase with a frame widget. An e-commerce checkout of a product within a frame widget can be accomplished while the video is playing. A short-form video from a library of short-form videos is chosen and populated into a frame widget on the webpage. A product within the short-form video can be selected. The product within the short-form video is added to a virtual purchase cart based on the selecting. A representation of the virtual purchase cart is displayed, wherein the representation is visible while viewing the short-form video. The video checkout experience can be accomplished on a merchant's e-commerce site or offsite, such as on a publisher's site. The short-form video, product selection, and purchase from a virtual purchase cart can be facilitated on such an e-commerce site, on a publisher's site, or on another such venue. The virtual purchase cart is used as part of the checkout process.

The system block diagram 800 can include a webpage 840. As explained throughout, the webpage can focus on virtually any topic, product, activity, writing, sales, and so on. The system block diagram 800 can further include an evaluating engine 842. The evaluating can include evaluation of products advertised; listed in text; displayed in picture format; displayed in video format; or represented by line drawing, icon, or emoji. The evaluating engine can determine the context of the webpage. The evaluating engine can use machine learning, image recognition, Latent Semantic Indexing, audio analysis, or other techniques to collect information about the webpage. The evaluating the webpage for products can be accomplished dynamically. The system block diagram 800 can include an identifying engine 844. The identifying engine can find one or more products that are highlighted, mentioned, shown, etc. in the webpage based on the evaluating engine. The identifying of one or more products can be based on machine learning. The system block diagram 800 can include one or more lists of products 846 that are related to the website that was evaluated. There can be any number of products stored in the list. The system block diagram 800 can include a short-form video server 852. The short-form video server can include a local server, a remote server, a cloud server, a distributed server, and so on. The short-form video server can deliver a short-form video from a library of short-form videos. The videos stored on the server can be uploaded by individuals, marketers, companies, content providers, etc. The system block diagram can include a choosing engine 854. The choosing engine can select at least one video from the server which is the best match with the list of products. The match can be based on topic, products, images, context, audio, and so on. The choosing of the at least one short-form video from the library can be based on machine learning. The system block diagram 800 can include a populating engine 860. The populating engine can select a frame widget and insert one or more videos from the choosing engine. The videos can include organic, sponsored, or promotional videos. The populating can include auctioning at least one frame in the frame widget. The system block diagram 800 can include a rendering engine 870. The rendering engine can render the at least one video to the user. The short-form video that is rendered can be rendered on a display associated with a device 810 such as a cell phone, tablet, computer, etc. The rendering the short-form video can be accomplished using a short-form video frame widget 812. The frame widget can include a video app, a web browser, and so on to display the rendered video in a frame associated with the frame widget. In embodiments, an in-frame shopping environment, a virtual shopping cart 814, product information, coupons, a call-to-action overlay 816, etc. can be rendered within the frame widget “on top” of the video or a portion of the video. The video, including any overlays, can be rendered initially at a position within the frame widget and can be moved to another position based on an action taken by the user. The video and all overlays can be expanded to occupy a larger portion of the display screen associated with the device. In embodiments, the video and overlays occupy substantially a third of the display screen.

The system block diagram can include a virtual purchase cart within the frame widget 850. The virtual purchase cart, which can include a virtual shopping cart, a virtual shopping bag, a virtual tote, etc., can be enabled based on a user action. The user can select a product via the in-frame shopping environment and can add it to the virtual purchase cart. The virtual shopping cart can represent one or more products selected for purchase by the user. The representing of the products can be accomplished while the user views the video. The products can include product P1, product P2, and so on, up to product PN. In embodiments a representation of the virtual purchase cart can be displayed on the device. The representation is visible while viewing the short-form video. Information associated with the virtual purchase cart and its contents can be provided to the rendering engine for display on the device.

The virtual purchase cart can be checked out. The system block diagram can include a checkout engine 880. The checking out can include verifying that the items selected by the user while viewing the short-form video are in stock; that information such as size, color, or configuration has been provided; that the user is identified by a hash identification tag; etc. When sufficient product information has been collected, final purchase of the products can be accomplished by completing the checkout from the virtual shopping cart.

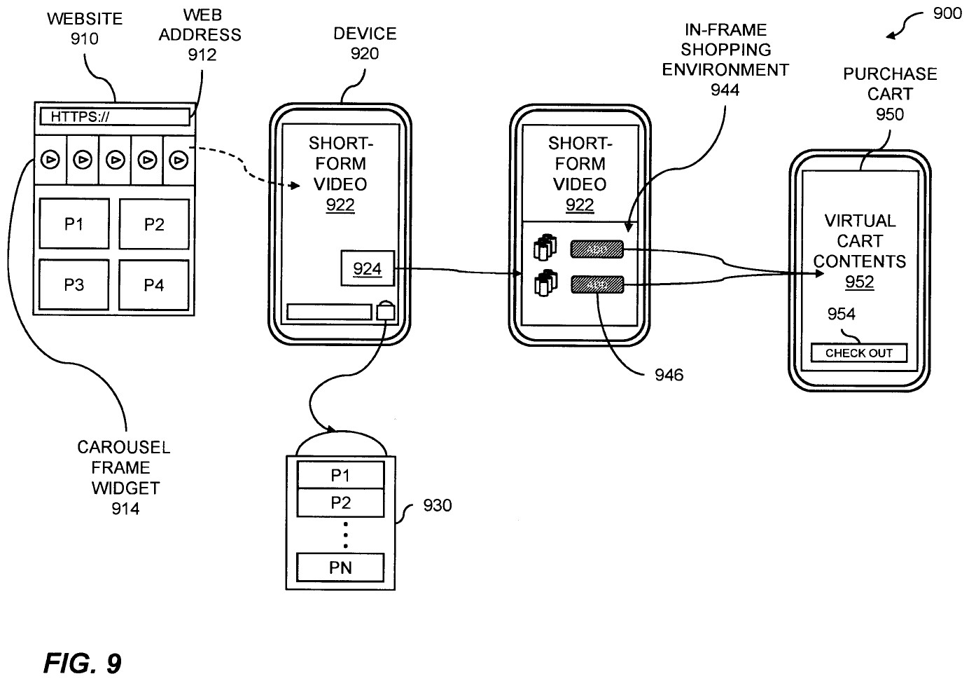

FIG. 9 is a system block diagram 900 for a frame-widget shopping operation. A user can view a video inside, for example, a carousel frame widget 914. The video can introduce, promote, endorse, etc. a product based on a user action such as a click, tap, etc. The user can choose to learn more about the product and, if interested, can add the product to a shopping bag or cart to purchase the product. The user can learn about the product, can purchase the product, etc., without leaving the video within the frame widget that contains the product. Instead, the video can continue to play while the user is learning more about the product, purchasing the product, etc. Another user action such as a click, tap, etc. can cause an in-frame shopping environment to be displayed, allowing the user to clip coupons, select product features, and add a product to the virtual purchase cart. In embodiments, a product details page can be displayed to provide for information hydration of data in support of an e-commerce activity. The frame-widget shopping operation can be accomplished by enabling an in-card shopping environment. The enabling can include tapping, clicking, swiping, mousing over or hovering, etc. on a call-to-action overlay. The add-to-cart operation enables e-commerce purchase within a short-form video environment.

A website 910 can include information associated with one or more products, where the products can be included within a short-form video, livestream video, and so on. The website can be accessible using a uniform resource locator (URL) or “web address” 912. The URL can be automatically input into a web browser to access the website. The website can include text, videos, audio files, and other content. The website can include product information associated with one or more products such as product P1, P2, P3, and P4. The website can include a frame widget such as a carousel frame widget 914 with at least one video. The video can include organic, sponsored, or promoted video content. The video can include livestream video, livestream video replay, a video stream, a short-form video, and the like. A device 920 can be used to display a short-form video 922 rendered within the frame widget. In embodiments, the video can be expanded to include up to the entire viewing area of the device. The device can include a hand-held electronic device, a portable electronic device, a desktop electronic device, and so on. A virtual purchase cart 930 can be displayed based on a user action such as a click, tap, etc. icon. The virtual purchase cart can include one or more products such as product P1, product P2, product PN and so on. In embodiments, the user can select a product such as product P1 to obtain detailed product information associated with the product. A call-to-action overlay 924 can also be displayed along with the video. The call-to-action overlay can include photos, videos, graphics, text such as “get deal”, and so on. Another user action such as a click, tap, etc. on the call-to-action overlay can reveal an in-frame shopping environment 944. The in-frame shopping environment can be displayed within the frame widget. Interacting with the product in the in-frame shopping environment can add the product to virtual cart contents 952. In embodiments, another user action can cause a product details page to display. The product details page can provide for information hydration of data in support of an e-commerce activity. The data can be obtained from a website hosted by a third party. The third-party website can include an information source, a search engine, an online retailer, and so on. The third-party website can include product information in the form of images, audio, text, videos, and the like.

The in-frame shopping environment can present details associated with the product such as size, color, price, availability, shipping and other costs, configuration information, and so on. A user can choose to add the product for purchase to the virtual purchase cart 950 by interacting with the shopping environment and clicking a shop icon, graphic, text, etc. such as an “Add” or “Add to Cart” icon 946. This user action enables a virtual purchase cart with the frame widget. The product that was added to the virtual purchase cart can be represented while viewing the short-form video. When the user is ready to purchase, the user can indicate this by tapping, clicking, etc. on an icon such as a “Check Out” icon 954. The checking out can be performed automatically. Embodiments include finalizing purchase of the product or products within the virtual purchase cart upon conclusion of the short-form video. In embodiments, the finalizing purchase can be accomplished using a batch order process. The batch processing can “combine” the product orders to take advantage of quantity discounts, discount codes, shipping discounts, and the like. In embodiments, the batch order processing can occur upon conclusion of the short-form video.

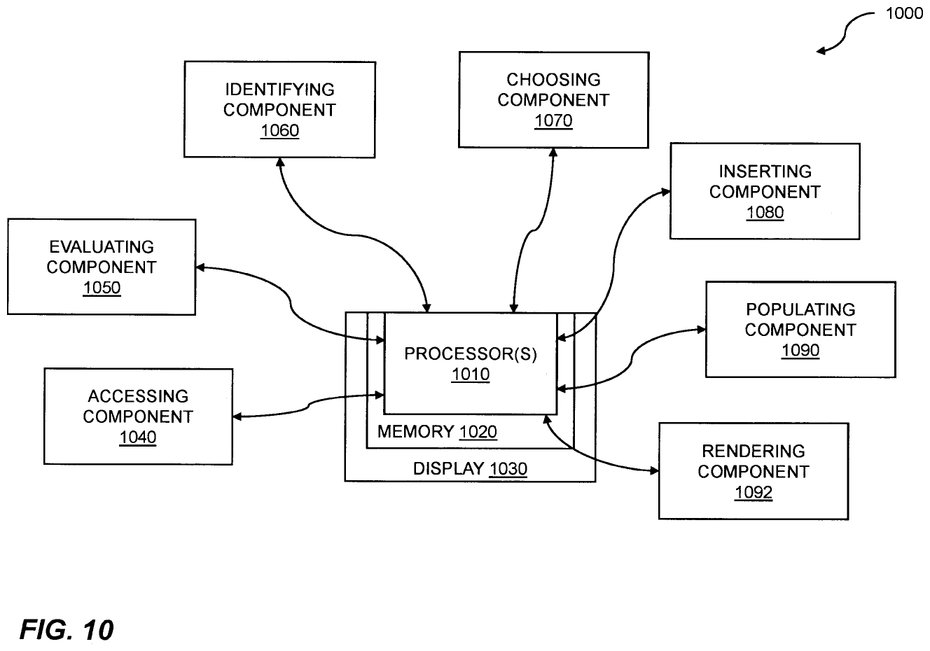

FIG. 10 is a system diagram for short-form videos displayed in a frame widget within a retail environment. The system 1000 can include one or more processors 1010 attached to a memory 1020 which stores instructions. The system 1000 can include a display 1030 coupled to the one or more processors 1010 for displaying data, video streams, videos, product information, virtual purchase cart contents, webpages, intermediate steps, instructions, and so on. In embodiments, one or more processors 1010 are attached to the memory 1020, wherein the one or more processors, when executing the instructions which are stored, are configured to: access a library of short-form videos; evaluate a webpage for products displayed or represented through the webpage within an online retail environment; identify one or more products on the webpage based on the evaluating; choose at least one short-form video from the library of short-form videos to include with the webpage, wherein the choosing is based on the identifying; insert a frame widget into the webpage, wherein placement of the frame widget in the webpage is based on the evaluating; populate the frame widget with the at least one short-form video that was chosen along with other videos; and render a video from the frame widget, based on a user action, wherein the video is from the at least one short-form video that was chosen.

The system 1000 can include an accessing component 1040. The accessing component can include functions and instructions for accessing a short-form video from a library of short-form videos. In embodiments, the short-form video can include a livestream video, a livestream replay, and so on. A live video stream can be created by and originate from variety of individuals or companies. The video stream can include content such as one or more products. The products can include items that the creator uses, recommends, promotes, endorses, and so on. The products can include various goods. In embodiments, the product can include a service. In other embodiments, the product can include a coupon or a membership. The short-form video can include a curated stream, videos from a streaming website, a video server, social media or other shared sites, and the like. A short-form video can include a video that displays for 30 seconds, 2.5 minutes, fewer than 10 minutes, and the like.

The system 1000 can include an evaluating component 1050. The evaluating component can include functions and instructions for evaluating a webpage for products displayed or represented through the webpage within an online retail environment. The webpage can have any focus such as travel, food, a blog or vlog, a collection of videos or images, etc. The website can highlight products or services that are recommended, reviewed, available for purchase, and so on. The evaluating component can include determining the context of the webpage, detecting keywords, scrubbing for images, searching for lookalike cohort data, analyzing audio, and the like. The webpage can be evaluated at the time it is viewed by a user or previously in anticipation of a future view by a user. The system 1000 can include an identifying component 1060. The identifying component can include functions and instructions for identifying one or more products on the webpage based on the evaluating. The products may be shown, mentioned, reviewed, listed for sale, purchased by other viewers, rated, etc. In a usage example, the identifying component can identify products on a grocery store webpage. The products can include items or services such as pet food or a home cleaning service. The identifying component can use machine learning. The products associated with the video may be stored in a list or in metadata associated with the video.

The system 1000 can include a choosing component 1070. The choosing component can include functions and instructions for choosing at least one short-form video from the library of short-form videos to include with the webpage, wherein the choosing is based on the identifying. The choice of the at least one video is based on the identifying of products on the webpage. The video which was chosen can present coupons to a viewer. In a usage example, the choosing component can select a video which is a review of a new soda drink when the identifying component identified other drinks such as soda, water, juice, etc. for sale on the website. The system 1000 can include an inserting component 1080. The inserting component can include functions and instructions for inserting a frame widget into the webpage, wherein placement of the frame widget in the webpage is based on the evaluating. The frame widget can be a carousel frame widget with frames for at least two videos, a story block frame widget with frames for at least one video, a grid frame widget with frames for at least two videos, or a floating short-form video player widget with a frame for at least one video. The placement of the frame widget on the webpage can be based on the evaluating of the webpage. The system 1000 can include a populating component 1090. The populating component can include functions and instructions for populating the frame widget with the at least one short-form video that was chosen along with other videos. If the number of short-form videos in the carousel frame widget, story block frame widget, grid frame widget, or floating short-form video player widget is too large to be displayed on the screen of the device, computer, PDA, phone, etc., the populating component can add an indicator such as an arrow, button, etc. to indicate to the viewer that additional short-form videos are available by scrolling in a direction. The viewer can access these additional short-form videos by tapping, clicking, or mousing over the indicator, causing the populating of additional videos that were chosen to occur as they are revealed in the frame. The system 1000 can include a rendering component 1092. The rendering component can include functions and instructions for rendering a video from the frame widget, based on a user action, wherein the video is from at least one short-form video that was chosen. In embodiments, the rendering occurs automatically after a period of time. In other embodiments, the rendering occurs as soon as the video comes into view by the user. The rendering can further include a thumbnail representing the video such as a video frame, image, graphic, etc. and can also include an indicator, such as an arrow, triangle, etc., for a user to play the video. The rendering can include presenting various types of coupons, an in-card shopping environment, a virtual purchase cart, a call-to-action overlay, information about products selected by the user, and so on. The user may interact with the rendering component by actions such as a click, tap, swipe, etc.

The system 1000 can include a computer program product embodied in a non-transitory computer readable medium for video manipulation, the computer program product comprising code which causes one or more processors to perform operations of: accessing a library of short-form videos; evaluating a webpage for products displayed or represented through the webpage within an online retail environment; identifying one or more products on the webpage based on the evaluating; choosing at least one short-form video from the library of short-form videos to include with the webpage, wherein the choosing is based on the identifying; inserting a frame widget into the webpage, wherein placement of the frame widget in the webpage is based on the evaluating; populating the frame widget with the at least one short-form video that was chosen along with other videos; and rendering a video from the frame widget, based on a user action, wherein the video is from the at least one short-form video that was chosen.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video manipulation comprising:
accessing a library of short-form videos;
evaluating a webpage for products displayed or represented through the webpage within an online retail environment;
identifying one or more products on the webpage based on the evaluating;
choosing at least one short-form video from the library of short-form videos to include with the webpage, wherein the choosing is based on the identifying;
inserting a frame widget into the webpage, wherein placement of the frame widget in the webpage is based on the evaluating;
populating the frame widget with the at least one short-form video that was chosen along with other videos; and
rendering a video from the frame widget, based on a user action, wherein the video is from the at least one short-form video that was chosen.

2. The method of claim 1 wherein metadata is used in the choosing of the at least one short-form video from the library.

3. The method of claim 2 wherein the metadata includes hashtags, repost velocity, user attributes, user history, ranking, product purchase history, view history, or user actions.

4. The method of claim 1 wherein the short-form videos comprise a livestream video or livestream video replay.

5. The method of claim 1 wherein the evaluating the webpage includes detecting and evaluating keywords, scrubbing the webpage for images, determining context of the webpage, analyzing audio, and searching for lookalike cohort metadata.

6. The method of claim 1 wherein the evaluating the webpage includes evaluation of products advertised; listed in text; displayed in picture format; displayed in video format; or represented by line drawing, icon, or emoji.

7. (canceled)

8. The method of claim 1 wherein the populating further comprises auctioning at least one frame in the frame widget.

9. The method of claim 8 wherein an auction bid is based on position of the short-form video in the frame widget.

10. The method of claim 8 wherein an auction bid is based on use of a coupon or other promotion.

11. The method of claim 8 wherein an auction bid is based on a keyword on the webpage or relevance of the video to the webpage content.

12. The method of claim 1 wherein the populating includes thumbnail representations of the at least one short-form video that was chosen along with other videos.

13. (canceled)

14. The method of claim 1 wherein the rendering of the short-form video presents a coupon to the user.

15. The method of claim 14 wherein the coupon is revealed to the user after watching the short-form video for a period of time.

16. The method of claim 15 wherein a frame in the frame widget is reserved for a type of coupon.

17. The method of claim 1 wherein the rendering the video comprises an in-frame shopping environment wherein the shopping environment is revealed based on another user action.

18. The method of claim 17 wherein the shopping environment includes an ability for a user to clip coupons.

19. The method of claim 17 wherein reveal of the shopping environment includes an ability to choose from multiple related products.

20. The method of claim 17 wherein reveal of the shopping environment includes an ability for the user to update quantity, price, size, color, or other variable aspects of a product.

21. The method of claim 17 wherein the shopping environment includes an ability for a user to display a product details page.

22. (canceled)

23. The method of claim 1 further comprising enabling a virtual purchase cart within the frame widget based a user action.

24. The method of claim 23 further comprising selecting, by a user, a product and adding the product to the virtual purchase cart.

25. The method of claim 24 further comprising representing the product, that was added to the virtual purchase cart, while viewing the at least one short-form video.

26. The method of claim 24 further comprising identifying the user by a hash identification tag.

27-29. (canceled)

30. The method of claim 1 wherein the frame widget includes a short-form video carousel including at least two short-form videos, a short-form video story block including at least one short-form video, a grid of at least two short-form videos, or a floating short-form video player including at least one short-form video.

31. (canceled)

32. A computer program product embodied in a non-transitory computer readable medium for video manipulation, the computer program product comprising code which causes one or more processors to perform operations of:
accessing a library of short-form videos;
evaluating a webpage for products displayed or represented through the webpage within an online retail environment;
identifying one or more products on the webpage based on the evaluating;
choosing at least one short-form video from the library of short-form videos to include with the webpage, wherein the choosing is based on the identifying;
inserting a frame widget into the webpage, wherein placement of the frame widget in the webpage is based on the evaluating;
populating the frame widget with the at least one short-form video that was chosen along with other videos; and
rendering a video from the frame widget, based on a user action, wherein the video is from the at least one short-form video that was chosen.

33. A computer system for video manipulation comprising:
a memory which stores instructions;
one or more processors attached to the memory, wherein the one or more processors, when executing the instructions which are stored, are configured to:
access a library of short-form videos;
evaluate a webpage for products displayed or represented through the webpage within an online retail environment;
identify one or more products on the webpage based on the evaluating;
choose at least one short-form video from the library of short-form videos to include with the webpage, wherein the choosing is based on the identifying;
insert a frame widget into the webpage, wherein placement of the frame widget in the webpage is based on the evaluating;
populate the frame widget with the at least one short-form video that was chosen along with other videos; and
render a video from the frame widget, based on a user action, wherein the video is from the at least one short-form video that was chosen.
